(19) United States
(12) Patent Application Publication
(10) Pub. No.: US 2010/0023636 A1
(43) Pub. Date: Jan. 28, 2010

(54) ONE-WAY MEDIA STREAMING SYSTEM AND METHOD THEREOF

(75) Inventors: Sin-Chang Huang, Taipei City (TW); Teng-Yi Huang, Taipei City (TW); Shih-Hsiu Wu, Pingtung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/272,744

(22) Filed: Nov. 17, 2008

(30) Foreign Application Priority Data
Jul. 24, 2008 (TW) 97128121

(51) Int. Cl. G06F 15/16

(52) U.S. Cl. 709/231

(57) ABSTRACT

A one-way media streaming system and a corresponding method thereof are provided. The system includes a relay server, a first user device, and a second user device. The first user device and the relay server determine the format of a specialized media streaming packet by exchanging at least one Session Initiation Protocol (SIP) option message. The first user device sends the specialized media streaming packet conforming to the format through a firewall to the relay server. The second user device sends a one-way media streaming packet to the relay server. The relay server changes the destination port of the one-way media streaming packet to be the same as the source port of the specialized media streaming packet of the first user device. The relay server then relays the one-way media streaming packet through the firewall to the first user device.

### CROSS-REFERENCE TO RELATED APPLICATION

This application claims the priority benefit of Taiwan application serial no. 97128121, filed on Jul. 24, 2008. The entirety of the above-mentioned patent application is hereby incorporated by reference herein and made a part of this specification.

### BACKGROUND OF THE INVENTION

1. Field of the Invention

The present invention relates to a one-way media streaming system and method thereof.

2. Description of Related Art

Media streaming refers to the transmission of multimedia data such as audio, image, or video data via network packets. The data is usually received and played at the same time at a receiving end. Media streaming technology has been widely applied in mobile communication and the Internet. For example, many websites offer streaming service of video footage, video conference, and Push to Talk over Cellular (POC), which also use media streaming technology.

FIG. 1 is a schematic diagram of a conventional point-to-point (P2P) media streaming system. The system includes user devices 101 and 102, and a relay server 110. The user devices 101 and 102 are mobile electronic devices such as cellular phones, personal digital assistants (PDA), or notebook computers. The user devices 101 and 102 use Session Initiation Protocol (SIP) to establish a connection and to obtain an Internet Protocol address (abbreviated as IP address) and a transmission port of the other party so as to transmit a media streaming packet of a Real-time Transport Protocol (RTP). In the system in FIG. 1, the SIP and RTP packets are both relayed between the user devices 101 and 102 by the relay server 110.

Between the user device 101 and the relay server 110 is a firewall 111 and between the user device 102 and the relay server 110 is a firewall 112. An ordinary firewall allows packets transmitted through a fixed transmission port and of a common protocol such as SIP to pass but blocks protocol packets of unfixed transmission ports such as RTP. However, an ordinary firewall has the following characteristic. If a packet whose source port is X enters the Internet from an internal network through the firewall and later if a packet whose destination port is also X tries to enter the internal network from the Internet, the firewall will usually allow the packet to pass without blocking it. Because of such a characteristic, bi-directional RTP streaming is not affected by the firewall and may maintain normal operation.

One-way RTP streaming has a problem as illustrated in FIG. 2. The services, POC and 183 Early Media, both use one-way RTP media streaming. In the example of FIG. 2, the user device 102 is a receiving end. The streaming of the POC and 183 Early Media are both one-way so the user device 102 will not transmit an RTP packet through the firewall 112. When the streaming packets of the POC and 183 Early Media reach the firewall 112, they will all be blocked and the user device 102 will not receive any streaming packets.

### SUMMARY OF THE INVENTION

The present invention provides a one-way media streaming method. The method includes the following steps. First, a first user device and a relay server determine a format of a specialized media streaming packet by exchanging at least one SIP option message. The first user device transmits the specialized media streaming packet conforming to the aforesaid format to the relay server through a firewall. A second user device transmits a one-way media streaming packet to the relay server, which changes a destination port of the one-way media streaming packet to be the same as a source port of the specialized media streaming packet. The relay server then relays the said one-way media streaming packet to the first user device through the firewall.

The present invention further provides a one-way media streaming system, including a relay server, a first user device, and a second user device. The first user device and the relay server determine a format of a specialized media streaming packet by exchanging at least one SIP option message. The first user device transmits the specialized media streaming packet conforming to the said format to the relay server through a firewall. The second user device transmits a one-way media streaming packet to the relay server, which changes a destination port of the one-way media streaming packet to be the same as a source port of the specialized media streaming packet. The relay server relays the said one-way media streaming packet to the first user device through the firewall.

The user device of the present invention may actively transmit a media streaming packet of a specialized format to the relay server through the firewall so as to enable a one-way media streaming packet from another user device to pass the firewall and reach the user device itself. The present invention uses SIP option messages which are compatible with current standards.

In order to make the aforementioned characteristics and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 and FIG. 2 are schematic diagrams of conventional media streaming systems.

FIG. 3 to FIG. 7 are schematic diagrams of a one-way media streaming system and a one-way media streaming method according to various embodiments of the present invention.

FIG. 8 is a schematic diagram of an SIP option message body according to an embodiment of the present invention.

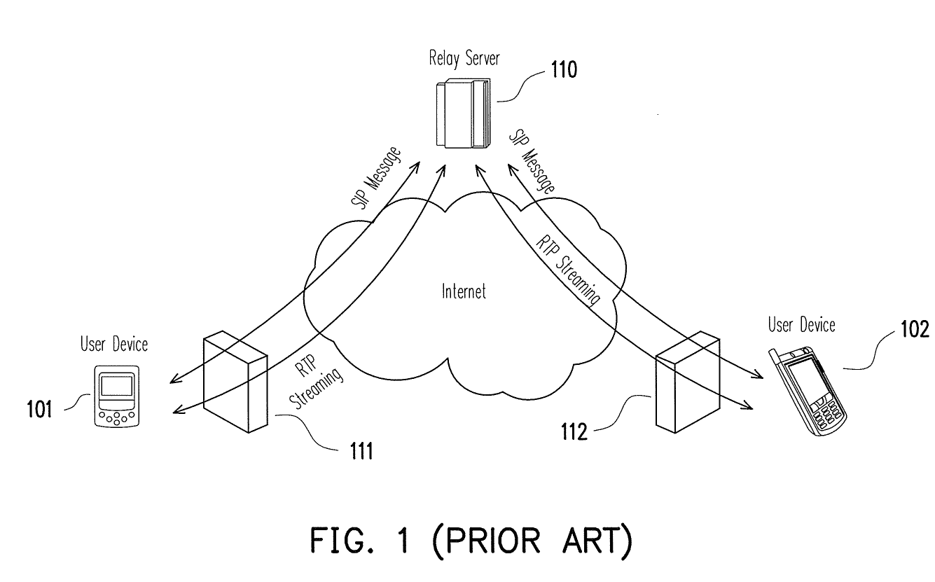

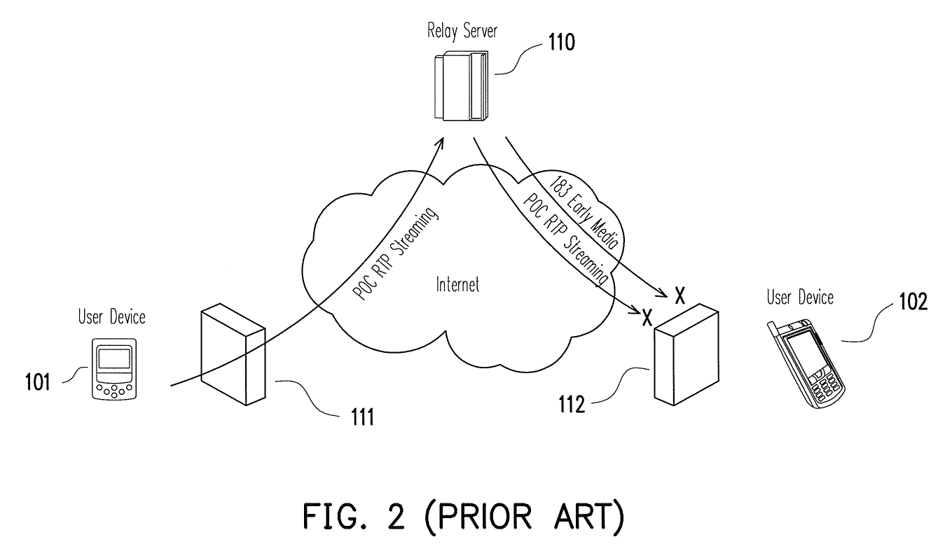

### DESCRIPTION OF EMBODIMENTS

In one embodiment of the present invention, a user device may actively transmit a media streaming packet of a specialized format every five or ten seconds through a firewall and to a relay server. As such, the firewall may keep a record such that a one-way media streaming packet from another user device may pass the firewall and reach the user device. That is, the user device actively transmits a specialized media streaming packet such that the originally one-way media streaming becomes bi-directional.

The present invention may be applied to any one-way media streaming. The following illustration uses the one-way RTP streaming of the POC and 183 Early Media as examples. The aforesaid specialized media streaming packet in this example is a specialized format RTP packet.

At least one SIP option message has to be transmitted between the user device and the relay server to decide the format of the specialized RTP packet before the user device transmits the specialized RTP packet. This process may be actively initiated by the user device or the relay server.

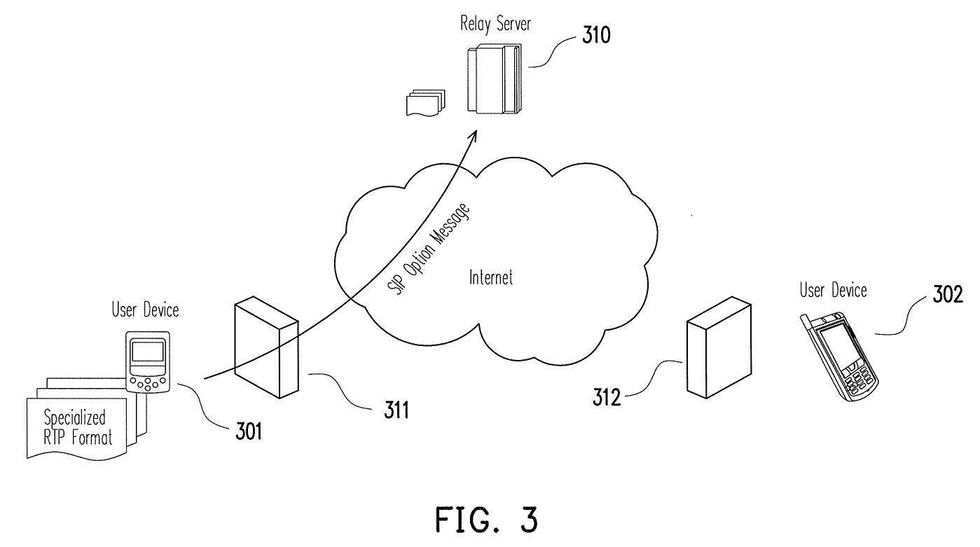

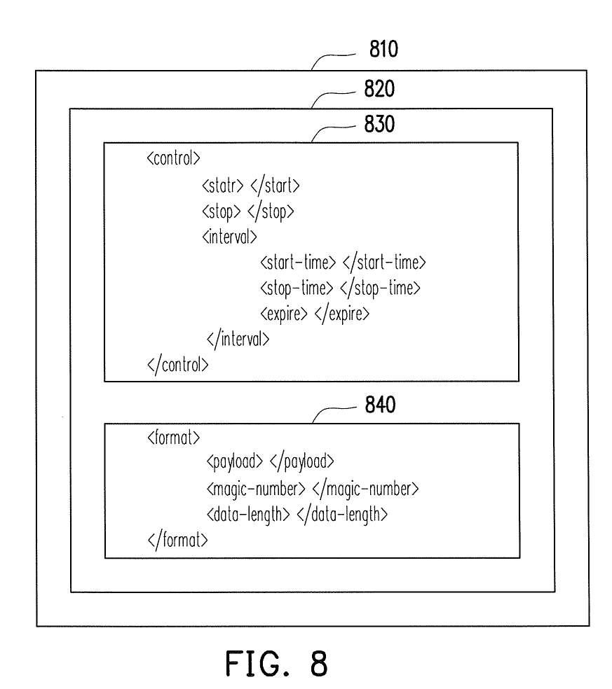

FIG. 3 illustrates a situation in which a user device actively initiates to determine a format of a specialized RTP packet in one embodiment of the present invention. A user device 301 actively transmits an SIP option message to a relay server 310 to inform the relay server 310 of the format and related information of the specialized RTP packet to be transmitted by the user device 301. The exchange of the SIP option message between the user device and the relay server conforms to current SIP specification. The SIP option message may include an XML document whose format may be defined by the user device. In the present embodiment, the user device uses self-defined XML elements to inform the relay server of the format and related information of the specialized RTP packet, as shown in FIG. 8.

FIG. 8 illustrates all elements that may be present in an XML document 820 of an SIP option message 810 in the present embodiment. A single SIP option message may only contain some of the elements but not all. The XML document 820 includes a control element 830 and a format element 840. The control element 830 is used to inform about related information about transmitting the specialized RTP packet. The format element 840 is used to inform about the format of the specialized RTP packet.

The control element 830 may include a start element, a stop element, and an interval element. If the start element is included in an SIP option message transmitted from the user device, this means that the user device starts to transmit the specialized RTP packet. If the start element is included in an SIP option message transmitted from the relay server, this means that the relay server requests the user device to start transmitting the specialized RTP packet. If the stop element is included in the SIP option message transmitted from the user device, this means that the user device stops transmitting the specialized RTP packet. If the stop element is included in the SIP option message transmitted from the relay server, this means that the relay server requests the user device to stop transmitting the specialized RTP packet. The start element and the stop element will not appear at the same time in an SIP option message. The interval element is used to inform about the time interval between transmissions of the specialized RTP packets, for example, the aforesaid five or ten seconds or other pre-determined time intervals.

The interval element may include a start-time element, a stop-time element, or an expire element. The start-time element and the stop-time element are used to inform the relay server of a start time and a stop time when the user device transmits the specialized RTP packet. The start-time element and the stop-time element must appear in pairs. The expire element is an alternative to the start-time element and the stop-time element and is used to inform the relay server of a duration time (e.g. one hour) when the user device transmits the specialized RTP packet.

In order for the relay server to correctly identify the specialized RTP packet, the format element 840 includes a payload element, a magic-number element, and a data-length element, which are used to specify the format of the specialized RTP packet. The payload element is used to inform the relay server of a payload type of the specialized RTP packet. To avoid a conflict with current payload type, a number in the undesignated section 77-95 or the dynamic reservation section 96-127 of the RTP payload type may be selected to be the payload type of the specialized RTP packet.

The magic-number element is used to inform the relay server of data content carried by the specialized RTP packet. The data content is the content value of the magic-number element.

The data-length element is used to inform the relay server of a length of the data carried by the specialized RTP packet. The specialized RTP packet may adopt a different data length from that of any regular one-way RTP packet in order for the relay server not to confuse a specialized RTP packet with a regularly transmitted one-way RTP packet. If a regular one-way RTP packet is generated by one of a plurality of codecs, each supporting a different encoding standard, g.711a, g.711u, g.723, g.729, for example and the data lengths of the packets possibly generated by the standards are included in a set, the data length of the specialized RTP packet can not belong to the set so that the relay server will not be confused.

The various names of the elements in the XML document 820 are not fixed. Other embodiments of the present invention may use different element names as long as the functions are the same.

The SIP option message transmitted from the user device 301 in FIG. 3 includes the control element 830 and the format element 840 in FIG. 8. The control element 830 may include a start element and an interval element. The interval element may include a start-time element, a stop-time element, or merely include an expire element.

After the user device 301 transmits the SIP option message, the relay server 310 may transmit another SIP option message to the user device 301, which includes the interval element used to change the time interval that the user device 301 transmits the specialized RTP packet.

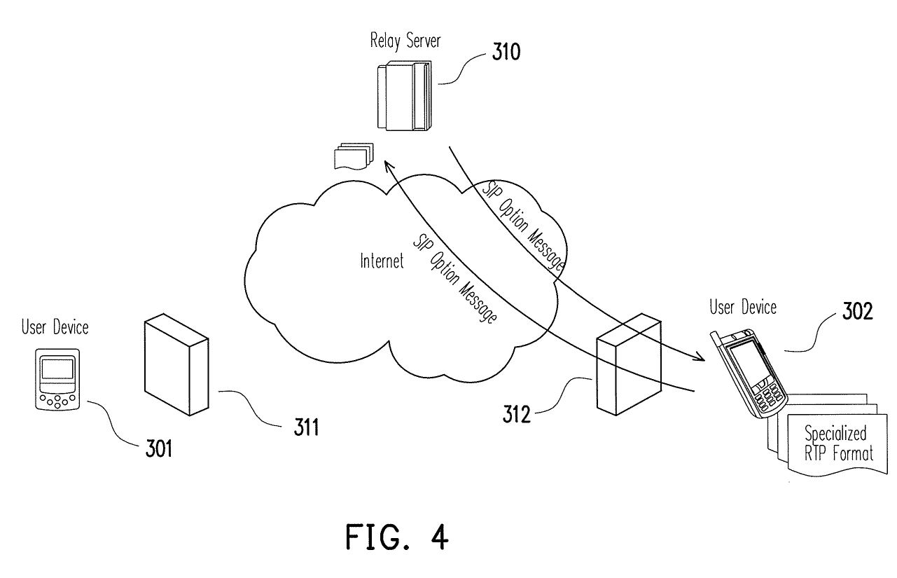

FIG. 4 illustrates a situation in which a relay server actively initiates to determine a format of a specialized RTP packet in another embodiment of the present invention. First, the relay server 310 transmits an SIP option message to a user device 302. The SIP option message may include a start element as shown in FIG. 8 to request the user device 302 to start to transmit a specialized RTP packet and to inform the relay server 310 of a format and related information of the specialized RTP packet. Then, the user device 302 transmits anther SIP option message to the relay server 310. The SIP option message is the same as the SIP option message transmitted by the user device 301 in FIG. 3 and is used to inform the relay server 310 of the format and related information of the specialized RTP packet transmitted by the user device 302.

After the user device 302 transmits the SIP option message, the relay server 310 may transmit again another SIP option message to the user device 302, which includes the interval element used to change the time interval that the user device 302 transmits the specialized RTP packet as shown in FIG. 8.

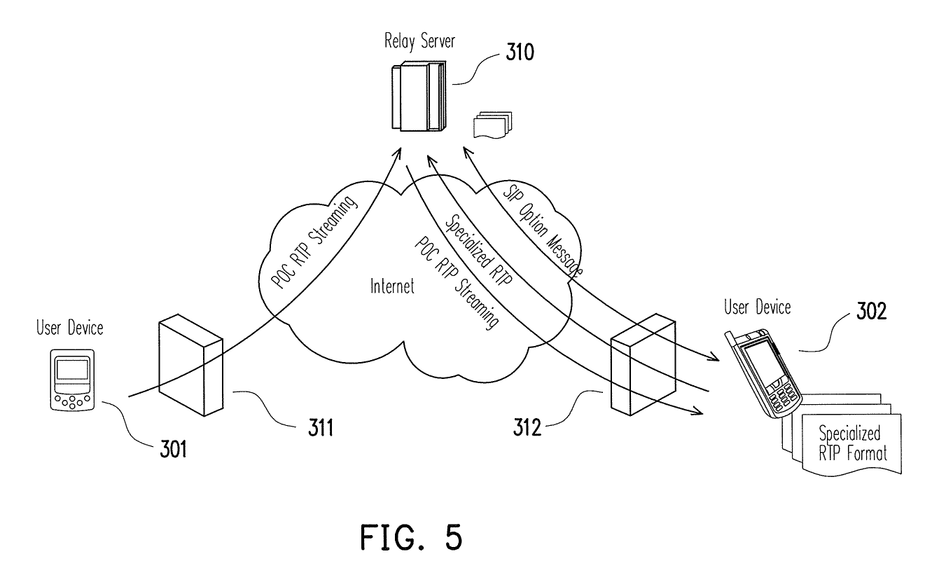

FIG. 5 illustrates a complete embodiment of the present invention, wherein a one-way media streaming system includes a relay server 310 and user devices 301 and 302. The said system executes the one-way media streaming method of the present embodiment. The user devices 301 and 302 are using a POC service and the user device 302 is a receiving end. First, the relay server 310 and the user device 302 may decide a format and related information of a specialized RTP packet using the method in FIG. 3 or FIG. 4. Then, the user device 302 transmits the specialized RTP packet conforming to the format to the relay server 310 through a firewall 312. After receiving the specialized RTP packet, the relay server 310 identifies the specialized RTP packet based on the format element 840 previously received, records a source port of the specialized RTP packet, and then discards the specialized RTP packet. This is because that the specialized RTP packet is merely used to allow the firewall to keep a record and need not be transmitted to other user devices. Thereafter, the user device 301 transmits a one-way POC RTP packet to the relay server 310 through a firewall 311. Based on previous records, the relay server 310 changes a destination port of the one-way POC RTP packet to be the same as a source port of the specialized RTP packet. Thus, when the relay server 310 transmits the one-way POC RTP packet to the user device 302 through the firewall 312, the firewall 312 will allow the one-way POC RTP packet to pass based on previous records so that the user device 302 may receive the one-way POC RTP packet.

When the service that the user device uses stops, the user device may transmit an SIP option message including a stop element to the relay server to inform the relay server that the user device stops transmitting the specialized RTP packet. Alternatively, the relay server may actively transmit an SIP option message including a stop element to the user device to request the user device to stop transmitting the specialized RTP packet.

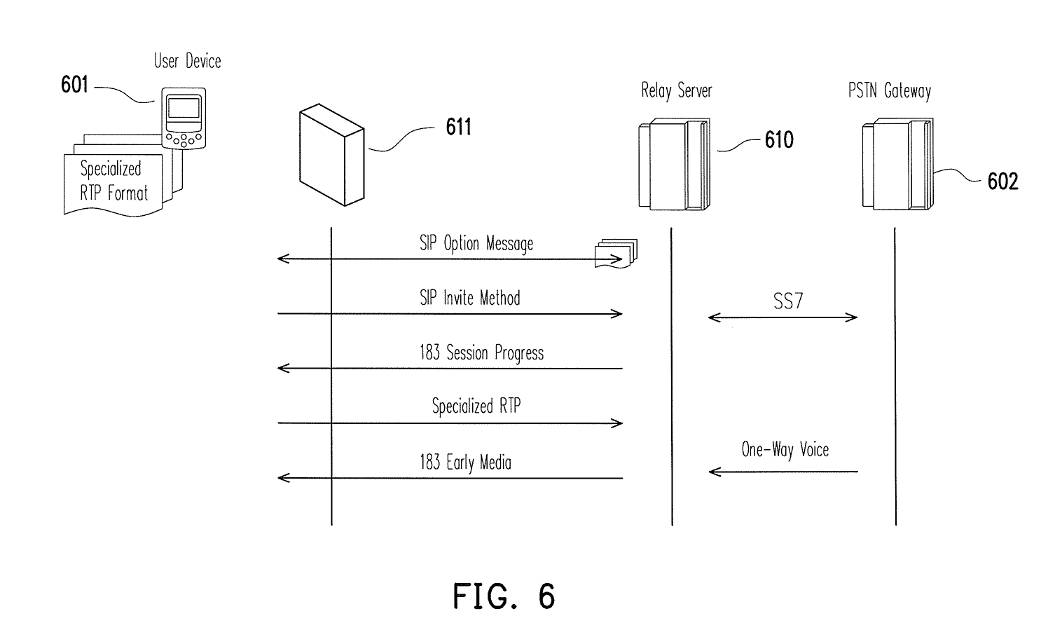

It is more and more common for people to use IP phones to place local calls. FIG. 6 illustrates an embodiment of the present invention used in this application. A user device 601 is an IP phone or a mobile electronic device with similar functions. Many telephone main systems have automatic messaging functions. The automatic messages used to prompt or answer user devices become one-way media streams on the Internet.

As shown in FIG. 6, first, a relay server 610 and the user device 601 may decide a format and related information of a specialized RTP packet using the method in FIG. 3 or FIG. 4. Then, the user device 601 transmits the specialized RTP packet conforming to the format to the relay server 610 through a firewall 611. After receiving the specialized RTP packet, the relay server 610 identifies the specialized RTP packet based on a format element 840 previously received, records a source port of the specialized RTP packet, and then discards the specialized RTP packet. A one-way voice message from a public switched telephone network (PSTN) will be transmitted to the relay server 610 through a PSTN gateway 602 and transformed to a one-way RTP stream of a 183 Early Media. The relay server 610 changes a destination port of the 183 Early Media packet to be the same as a source port of the specialized RTP packet. When the relay server 610 relays the 183 Early Media packet to the user device 601 through the firewall 611, the firewall 611 allows the 183 Early Media packet to pass based on previous passing records of the specialized RTP packet such that the user device 601 may receive the 183 Early Media packet.

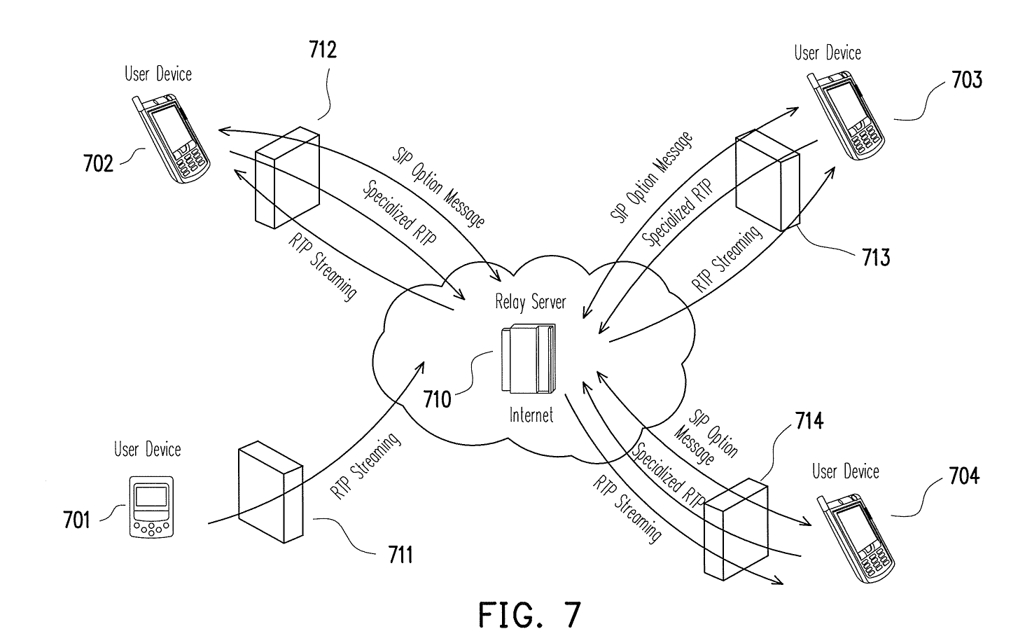

The present invention may be applied in an environment with more user devices. FIG. 7 illustrates an embodiment of the present invention of a video conference, wherein the system includes a relay server 710 and four user devices 701-704. At a video conference, images of a user device need to be transmitted to other user devices, which is also a one-way media streaming. As shown in FIG. 7, transmission from the user device 701 to the user devices 702-704 is illustrated as an example. The relay server 710 and the user devices 702-704 may decide a format and related information of the specialized RTP packet using the method of FIG. 3 or FIG. 4. Then, the user devices 702-704 respectively transmit a specialized RTP packet periodically to the relay server 710 through firewalls 712-714. As such, a one-way RTP stream from the user device 701 may pass the firewall and be received by the user devices 702-704.

In summary, the user device of the present invention may actively transmit a media streaming packet of a specialized format to the relay server through the firewall so as to enable a one-way media streaming packet from another user device to pass the firewall and reach the user device itself. The present invention uses SIP option messages which are compatible with current standards. The specialized media streaming packet is easy in implementation and doesn't affect normal behavior of the relay server. In addition, the format of the specialized media streaming packet may be dynamically decided to reduce the chance of malicious attacks.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A one-way media streaming method, comprising:
a first user device and a relay server determining a format of a specialized media streaming packet by exchanging at least one SIP option message;
the first user device transmitting the specialized media streaming packet conforming to the format to the relay server through a firewall;
a second user device transmitting a one-way media streaming packet to the relay server;
the relay server changing a destination port of the one-way media streaming packet to be the same as a source port of the specialized media streaming packet; and
the relay server transmitting the one-way media streaming packet to the first user device through the firewall.

2. The one-way media streaming method according to claim 1, wherein the step of determining the format comprises:
the first user device transmitting a first SIP option message to the relay server to inform the relay server of a time interval and the format of the specialized media streaming packet transmitted by the first user device.

3. The one-way media streaming method according to claim 2, wherein the first SIP option message comprises an XML document, the XML document comprises a control element and a format element and the format element informs about the time interval.

4. The one-way media streaming method according to claim 3, wherein the control element comprises a start element and an interval element, the start element informs the relay server that the first user device starts to transmit the specialized media streaming packet, and the interval element informs about the time interval.

5. The one-way media streaming method according to claim 4, wherein the control element further comprises a start-time element and a stop-time element, the start-time element informs the relay server of a time that the first user device starts to transmit the specialized media streaming packet, and the stop-time element informs the relay server of a time that the first user device stops transmitting the specialized media streaming packet.

6. The one-way media streaming method according to claim 4, wherein the control element further comprises an expire element and the expire element informs the relay server of a duration time that the first user device transmits the specialized media streaming packet.

7. The one-way media streaming method according to claim 3, wherein the format element comprises a payload element, a magic-number element, and a data-length element, the payload element informs the relay server of a payload type of the specialized media streaming packet, the magic-number element informs the relay server of data content carried by the specialized media streaming packet, and the data-length element informs the relay server of a length of the data carried by the specialized media streaming packet.

8. The one-way media streaming method according to claim 7, wherein the payload element is selected from an undesignated section or a dynamic reservation section of a payload type of RTP.

9. The one-way media streaming method according to claim 7, wherein the one-way media streaming packet is generated by one of a plurality of codecs, each of the codecs supports a different encoding standard, and the data-length element is not equal to a length of any specialized media streaming packet generated by the plurality of codecs.

10. The one-way media streaming method according to claim 2, further comprising:
after the relay server receiving the first SIP option message, the relay server transmitting a second SIP option message to the first user device to change the time interval.

11. The one-way media streaming method according to claim 1, wherein the step of determining the format comprises:
the relay server transmitting a third SIP option message to the first user device to request the first user device to inform about the format; and
the first user device transmitting a fourth SIP option message to the relay server to inform the relay server of a time interval and the format of the specialized media streaming packet transmitted by the first user device.

12. The one-way media streaming method according to claim 1, wherein the relay server discards the specialized media streaming packet after receiving the specialized media streaming packet.

13. The one-way media streaming method according to claim 1, further comprising:
the first user device transmitting a fifth SIP option message to the relay server to inform the relay server that the first user device stops transmitting the specialized media streaming packet.

14. The one-way media streaming method according to claim 13, wherein the fifth SIP option message comprises an XML document, the XML document comprises a stop element and the stop element informs the relay server that the first user device stops transmitting the specialized media streaming packet.

15. The one-way media streaming method according to claim 1, farther comprising:
the relay server transmitting a sixth SIP option message to the first user device to request the first user device to stop transmitting the specialized media streaming packet.

16. A one-way media streaming system, comprising:
a relay server;
a first user device; and
a second user device, wherein
the first user device and the relay server determine a format of a specialized media streaming packet by exchanging at least one SIP option message, the first user device transmits the specialized media streaming packet conforming to the format to the relay server through a firewall,
the second user device transmits a one-way media streaming packet to the relay server,
the relay server changes a destination port of the one-way media streaming packet to be the same as a source port of the specialized media streaming packet, and the relay server then transmits the one-way media streaming packet to the first user device through the firewall.

17. The one-way media streaming system according to claim 16, wherein when determining the format, the first user device transmits a first SIP option message to the relay server to inform the relay server of a time interval and the format of the specialized media streaming packet transmitted by the first user device.

18. The one-way media streaming system according to claim 17, wherein the first SIP option message also informs the relay server of a time that the first user device starts transmitting the specialized media streaming packet and another time that the first user device stops transmitting the specialized media streaming packet.

19. The one-way media streaming system according to claim 17, wherein the first SIP option message also informs the relay server of a duration time that the first user device transmits the specialized media streaming packet.

20. The one-way media streaming system according to claim 17, wherein the first SIP option message comprises a payload element, a magic-number element, and a data-length element, the payload element informs the relay server of a payload type of the specialized media streaming packet, the magic-number element informs the relay server of data content carried by the specialized media streaming packet, and the data-length element informs the relay server of a length of data carried by the specialized media streaming packet.

21. The one-way media streaming system according to claim 20, wherein the payload element is selected from an undesignated section or a dynamic reservation section of a payload type of RTP.

22. The one-way media streaming system according to claim 20, wherein the one-way media streaming packet is generated by one of a plurality of codecs, each of the codes supports a different encoding standard, and the data-length element is not equal to a length of any specialized media streaming packet generated by the plurality of codecs.

23. The one-way media streaming system according to claim 16, wherein the relay server further transmits a third SIP option message to the first user device to request the first user device to inform about the format, and the first user device further transmits a fourth SIP option message to the relay server to inform the relay server of a time interval and the format of the specialized media streaming packet transmitted by the first user device.

24. The one-way media streaming system according to claim 16, wherein the relay server discards the specialized media streaming packet after receiving the specialized media streaming packet.

25. The one-way media streaming system according to claim 16, wherein the first user device further transmits a fifth SIP option message to the relay server to inform the relay server that the first user device stops transmitting the specialized media streaming packet.

26. The one-way media streaming system according to claim 16, wherein the relay server further transmits a sixth SIP option message to the first user device to request the first user device to stop transmitting the specialized media streaming packet.
